(19) United States
(12) Patent Application Publication
(10) Pub. No.: US 2012/0179074 A1
(43) Pub. Date: Jul. 12, 2012

(54) MASSAGE MACHINE

(75) Inventors: Munekiyo Ikebe, Shiga (JP); Takashi Yukawa, Osaka (JP); Masaki Nagano, Osaka (JP)

(73) Assignee: Panasonic Corporation, Kadoma-shi, Osaka (JP)

(21) Appl. No.: 13/393,100

(22) PCT Filed: Sep. 3, 2010
(86) PCT No.: PCT/JP2010/065119

§ 371 Date: Apr. 3, 2012

(30) Foreign Application Priority Data
Sep. 18, 2009 (JP) 2009-217737

(51) Int. Cl. A61H 1/00

(52) U.S. Cl. 601/19

(57) ABSTRACT

A massage machine includes a seat and a backrest, and a massage mechanism including a massaging element is provided within the backrest. The massaging element is connected to an arm of the massage mechanism and includes a heat transfer unit in which a heat source is contained and which is able to transfer to the user the heat transferred from the heat source. A rubbing roller is supported by the heat transfer unit on the arm.

### TECHNICAL FIELD

The present invention relates to a massage machine including a backrest that incorporates a massage mechanism.

### BACKGROUND ART

A chair type massage machines include, for example, a backrest that incorporates a massage mechanism having rubbing rollers. The massage machines press the rubbing rollers against a trigger point or meridian and produce a predetermined motion to enhance blood circulation and resolve shoulder or back stiffness. Such massage machines have become widely used in average households and public facilities.

To perform massages close to what would be given by a person, recent massage machines include a heat source in the massage mechanism. This adds human warmth to the massaging with the massaging motion of the rubbing roller (refer to, for example, patent publication 1).

In the massage machine of patent publication 1, the rubbing roller, which is pressed against the user's body, includes two semispherical elastic members holding in between a heat transferring means (disk), which accommodates a heat source. Heat is transferred from the heat source through the heat transferring means to the user's body.

### PRIOR ART DOCUMENTS

Patent Publication 1: Japanese Laid-Open Patent Publication No. 2008-284338

### SUMMARY OF THE INVENTION

### Problems that are to be Solved by the Invention

In the above massage machine, the heat transferring means is held between two generally semispherical elastic members. In other words, the rubbing roller has a separable structure formed by the two elastic members. Thus, from the viewpoint of rigidity and durability for the rubbing roller, there is room for improvement.

It is an object of the present invention to provide a massage machine that applies heat to the user while increasing the rigidity and durability of the rubbing roller.

### Means for Solving the Problems

One aspect of the present invention is a massage machine. The massage machine includes a seat and a backrest. A massage mechanism is arranged in the backrest. A massaging element is arranged in the massage mechanism. An arm is connected to the massage mechanism. A heat transfer unit is connected to the arm. The heat transfer unit accommodates a heat source and is capable of transferring heat from the heat source to a user. A rubbing roller is supported by the heat transfer unit on the arm.

In this structure, a rubbing roller is not separated to hold a heat transferring means in between. Thus, the rubbing roller may be formed by a single component. Accordingly, the rigidity and durability of the rubbing roller can be improved while transferring heat to the user with the heat transfer unit. Further, the number of components in the rubbing roller can be reduced. This facilitates assembling during manufacturing.

### BRIEF DESCRIPTION OF THE DRAWINGS

FIG. 1 is a schematic diagram showing one embodiment of a massage machine.

FIG. 2 is a front view showing a massaging element arranged in the massage machine of FIG. 1.

FIG. 3 is an exploded perspective view showing the massaging element of FIG. 2.

FIG. 4 is a partial cross-sectional view showing the massaging element of FIG. 2.

FIG. 5 is a schematic block diagram of a temperature control mechanism arranged in the massage machine of FIG. 1.

FIG. 6 is a schematic graph illustrating the temperature control executed by the temperature control mechanism of FIG. 5.

FIGS. 7(a) and 7(b) are schematic diagrams showing a massaging motion produced near the neck by the massage machine of FIG. 1.

FIGS. 8(a) and 8(b) are schematic diagrams showing a massaging motion produced near the back by the massage machine of FIG. 1.

FIG. 9 is a schematic view showing a further example of a heater unit arranged in the massage machine of FIG. 1.

FIG. 10 is a schematic view showing a further example of a heater unit arranged in the massage machine of FIG. 1.

FIG. 11 is a schematic view showing a further example of a heater unit arranged in the massage machine of FIG. 1.

### EMBODIMENTS OF THE INVENTION

One embodiment of a massage machine 10 will now be described with reference to the drawings.

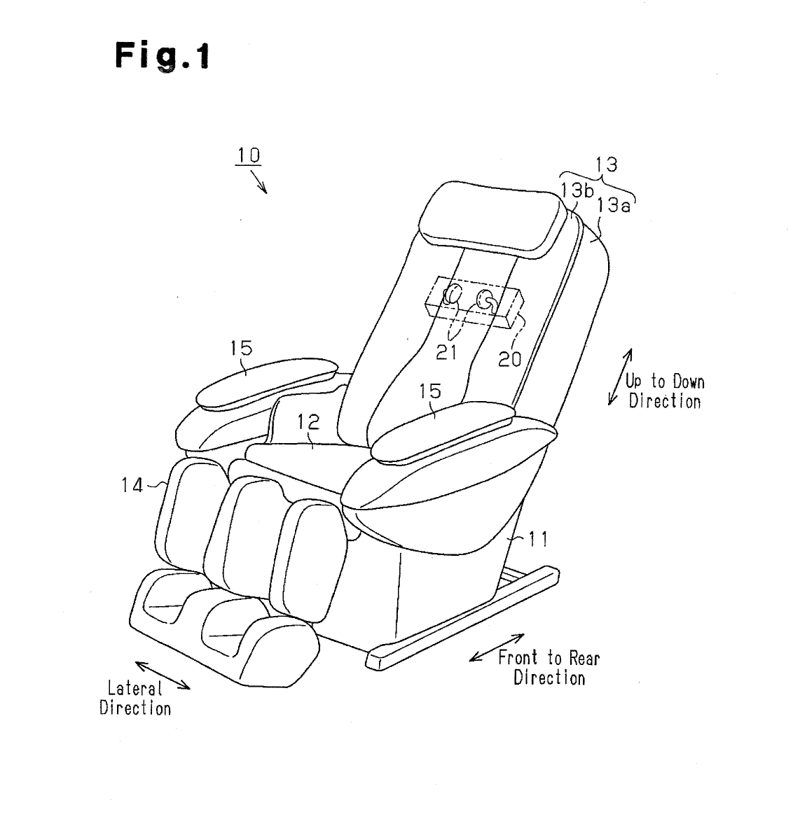

FIG. 1 schematically shows the structure of the massage machine 10. As shown in FIG. 1, the massage machine 10 includes a leg 11 arranged on a floor surface, which is not shown in the drawing. A seat 12, onto which a user can be seated, is fixed to an upper part of the leg 11. A reclinable backrest 13 is arranged at a rear part of the seat 12 to rest the user's back. A reclinable ottoman 14 is arranged at a front part of the seat 12 to rest the user's feet. Further, armrests 15 are arranged at opposite sides of the seat 12 extending from the backrest 13 to the front of the seat 12 to rest the user's arms.

The backrest 13 includes a backrest body 13a and a cover 13b, which covers a front surface of the backrest body 13a. The backrest body 13a includes a massage mechanism 20, which is arranged in a body case (not shown) having an open front and formed from a hard resin material. Guide rails (not shown) are arranged in the body case along the vertical direction of the backrest 13. The massage mechanism 20 is coupled to the guide rails in a vertically movable manner. The massage mechanism 20 includes various types of drive motors, which are not shown in the drawings, to vertically move the massage mechanism 20. The massage mechanism 20 includes two massaging elements 21, which are driven by a drive motor, and produces a predetermined massaging motion with the two massaging elements 21.

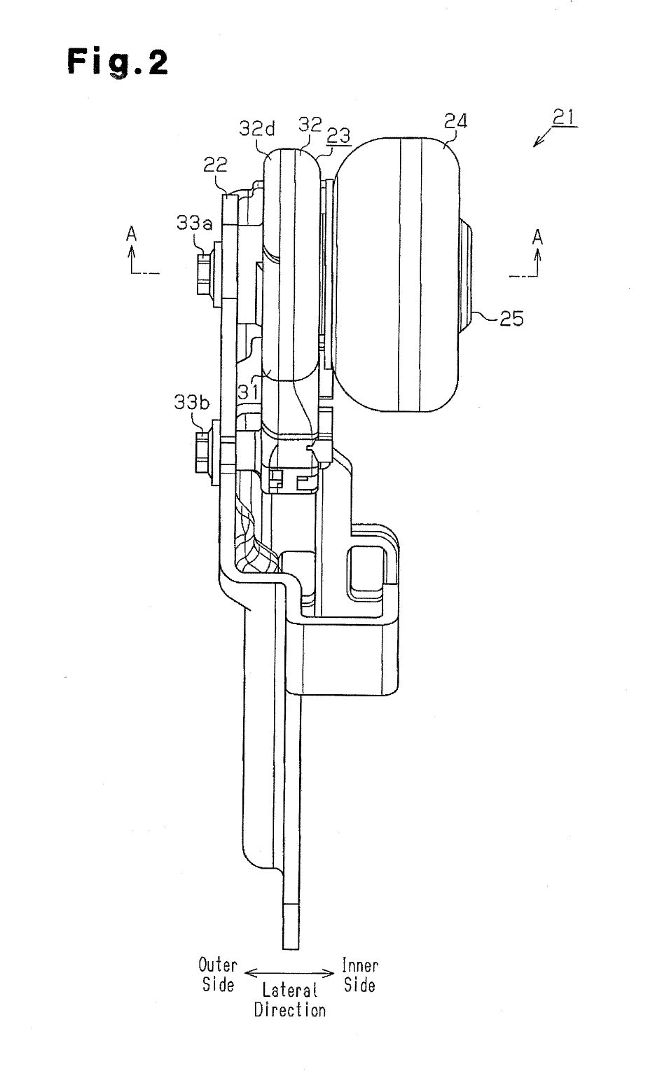

The structure of the massaging elements 21 will now be described. The two massaging elements 21 have the same structure. Thus, the structure of only one of the massaging elements 21 will be described. As shown in FIG. 2, the massaging element 21 includes an arm 22, which is connected to the massage mechanism 20, a heater unit 23, which is arranged on the arm 22 and serves as a heat transfer unit, a rubbing roller 24, and a fixed member 25, which is connected to the heater unit 23. In the present embodiment, the rubbing roller 24 is held between the heater unit 23 and the fixed member 25. The fixed member 25 is formed from aluminum that has high thermal conductance.

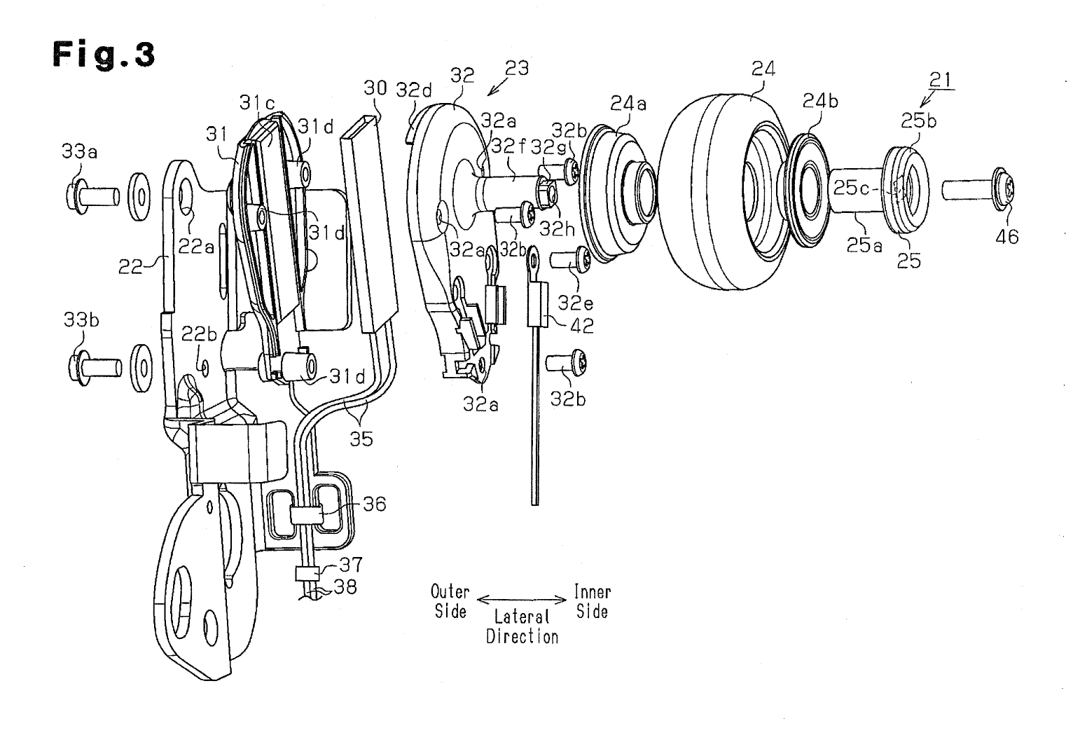

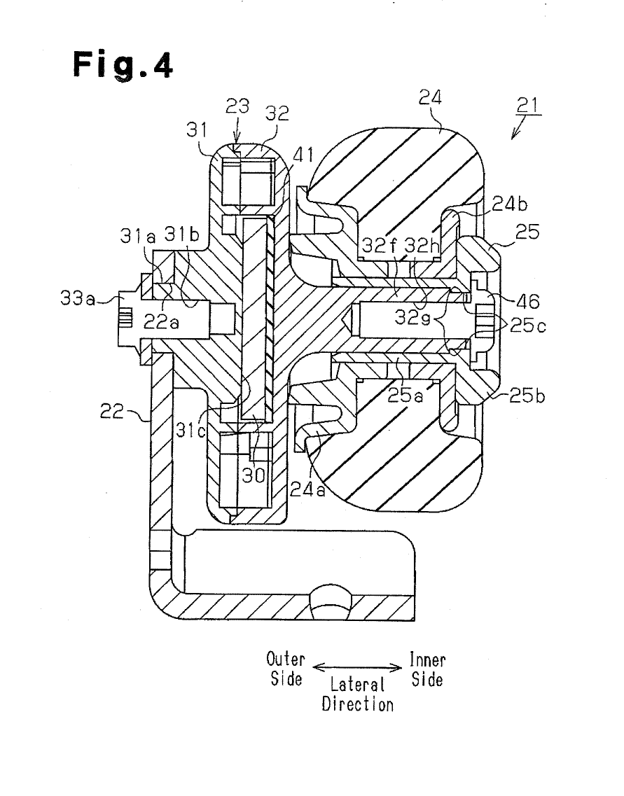

As shown in FIGS. 3 and 4, each heater unit 23 includes a positive temperature coefficient (PTC) heater 30, which serves as a heat source, and a first case member 31 and second case member 32, which accommodate the PTC heater 30. In a lateral direction, which is the direction between the two massaging elements 21, the heater unit 23 is arranged at an inner side of the arm 22. The case members 31 and 32 use aluminum as a material having high thermal conductivity and rigidity.

The first case member 31 is arranged outward in the lateral direction from the second case member 32 and fixed by screws 33a and 33b to the arm 22. The first case member 31 includes an outer surface at the outer side in the lateral direction. A projection 31a (refer to FIG. 4) projecting outward in the lateral direction is formed on the outer surface. The projection 31a, which includes a first threaded hole 31b, is inserted into a large diameter through hole 22a, which extends through the arm 22 in the lateral direction. A second threaded hole (not shown) is formed in the outer surface of the first case member 31 at a position aligned with a small diameter through hole 22b, which extends through the arm 22 in the lateral direction. Screws 33a and 33b are respectively fastened to the first threaded hole 31b and second threaded hole to fix the first case member 31 to the arm 22.

The first case member 31 includes an inner surface at the inner side in the lateral direction. As shown in FIGS. 3 and 4, an abutment portion 31c, which abuts the PTC heater 30, is formed on the inner surface of the first case member 31 projecting inward in the lateral direction. Further, the inner surface of the first case member 31 includes three projections 31d, which project inward in the lateral direction.

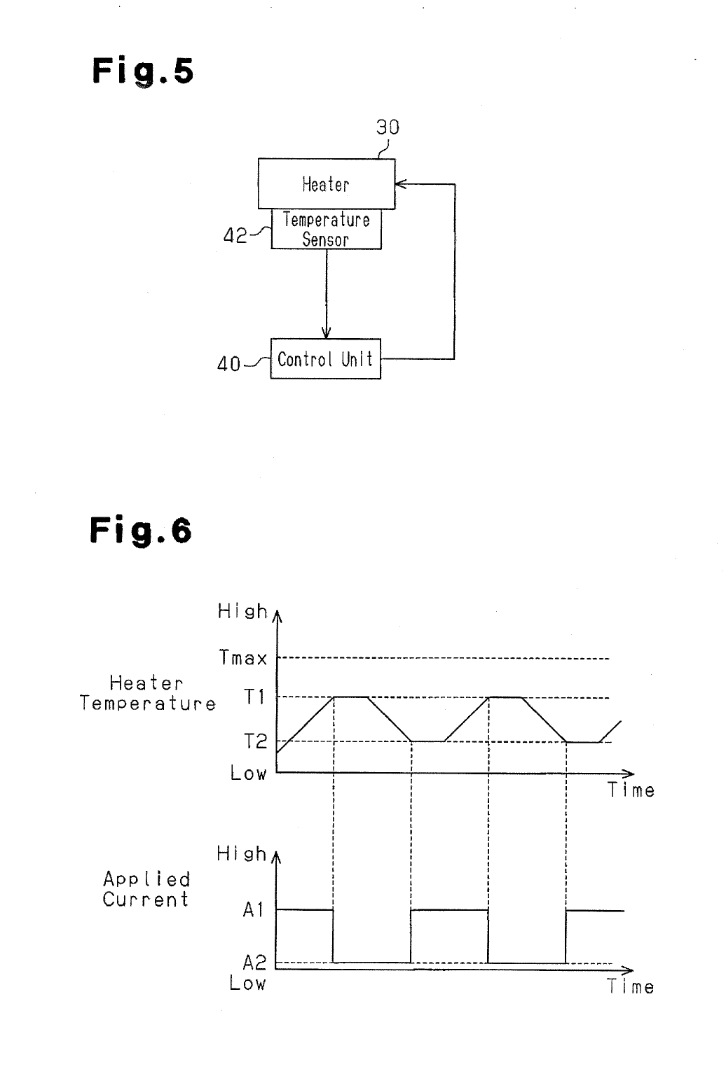

As shown in FIG. 5, the PTC heater 30 is electrically connected to a control unit 40, which controls the current applied to the PTC heater 30. As shown in FIG. 3, a power supply wire 35, which is for supplying power, is connected to the PTC heater 30. The power supply wire 35 is fastened by a fastening member 36 to the arm 22 so that its position in relation with the PTC heater 30 does not change. Further, the power supply wire 35 is connected by a connector 37 to a power supply wire 38, which differs from the power supply wire 35. The power supply wire 38 is connected, for example, to the control unit 40. The control unit 40 controls the current applied to the PTC heater 30 and adjusts the temperature.

The second case member 32 includes an inner surface at the outer side in the lateral direction. A rubber pad 41, which has a high thermal conductivity and elasticity and is formed from a silicone, is arranged on the inner surface at a position corresponding to the PTC heater 30. Further, the second case member 32 includes three through holes 32a corresponding to threaded holes formed in the three projections 31d of the first case member 31. The three projections 31d and the three through holes 32a function as alignment portions that align the first case member 31 and the second case member 32. Screws 32b are inserted into the through holes 32a and fastened to the threaded holes in the projections 31d of the first case member 31 to couple the first case member 31 to the second case member 32. As shown in FIG. 4, this holds the PTC heater 30 between the abutment portion 31c of the first case member 31 and the rubber pad 41 arranged in the second case member 32 and thereby restricts movement of the PTC heater 30. Thus, chattering caused by movement of the PTC heater 30 is suppressed. The rubber pad 41 is elastically deformed in accordance with the clamping pressure applied by the second case member 32 and the PTC heater 30. In other words, the PTC heater 30 is in contact under pressure with the second case member 32, and heat can be efficiently transferred to the second case member 32.

As shown in FIG. 2, the second case member 32 includes an abutment portion 32d (i.e., opposing portion opposing the user's body), which can abut the user's body through the cover 13b. The abutment portion 32d has a curved shape. Further, the abutment portion 32d, which is extended outward in the lateral direction by about the same amount as the thickness (length in the lateral direction) of the first case member 31, concentrates the heat of the PTC heater 30 in the second case member 32 and minimizes the diffusion of heat to outside the abutment portion 32d. It is preferred that the first case member 31 and the second case member 32 be shaped in conformance with the PTC heater 30 at parts other than the abutment portion 32d.

The second case member 32 includes an outer surface at the inner side in the lateral direction. As shown in FIG. 3, a temperature sensor 42 is fixed by a screw 32e to the outer surface of the second case member 32. The temperature sensor 42 is electrically connected to the control unit 40. The heat of the PTC heater 30 is transferred to the second case member 32, which is the shell of the heater unit 23, and the temperature sensor 42 monitors the temperature of the heat.

As shown in FIG. 4, an extension 32f, which projects inward in the lateral direction, is formed on the outer surface of the second case member 32. A generally tetragonal engagement protrusion 32g is formed on a distal end of the extension 32f in the extending direction. The fixed member 25 is fitted to the extension 32f of the second case member 32. In a state in which the fixed member 25 is fitted to the extension 32f, a screw 46 is fastened to a threaded hole 32h formed in the extension 32f to prevent separation of the fixed member 25.

The fixed member 25 is generally cylindrical. The fixed member 25 includes a cylindrical portion 25a, which has a generally constant outer shape, and an enlarged diameter portion 25b, which is formed at one axial side of the cylindrical portion 25a and has a larger diameter than the cylindrical portion 25a. An inner surface in one end of the cylindrical portion 25a defines an engagement bore 25c, which is generally tetragonal and engages with the engagement protrusion 32g of the extension 32f of the second case member 32. Engagement of the engagement protrusion 32g and the engagement bore 25c in a rotation direction prevents rotation of the fixed member 25.

The rubbing roller 24, which is rotatably supported by two bearings 24a and 24b, is arranged on an outer circumferential surface of the cylindrical portion 25a of the fixed member 25. The rubbing roller 24 is formed by a single elastic member. Thus, in comparison to a separable type rubbing roller formed by a plurality of members like in the prior art, the rigidity and durability of the rubbing roller can be increased.

Further, the rubbing roller 24 is formed to have a radius that is slightly greater (approximately 3 mm) than the distance from the axis of the extension 32f of the second case member 32 to the abutment portion 32d of the case member 32. Thus, when the rubbing roller 24 abuts the user's body through the cover 13b and is deformed by the contact pressure, the abutment portion 32d of the second case member 32, which is formed by a rigid body, slightly contacts the user to transfer only heat in a preferred manner. Moreover, the second case member 32 keeps the deformation amount of the rubbing roller 24, which is formed by the elastic member, within a desirable range and thereby prolongs the life of the rubbing roller 24.

The bearings 24a and 24b are formed by a thermally insulative material. Thus, the transfer of heat to the rubbing roller 24, which is formed by the elastic member, is suppressed.

The temperature control of the heater unit 23 and the massage with the rubbing rollers 24 performed in parallel with the temperature control will now be described.

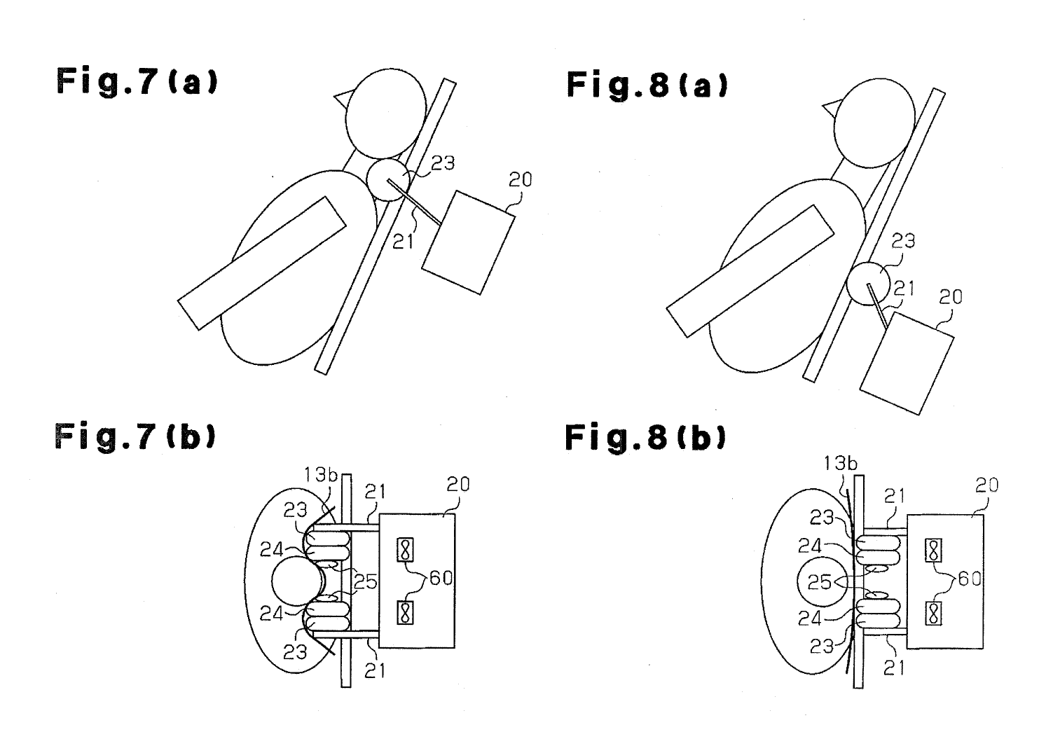

When a power switch (not shown) of the massage machine 10 is turned on, and, for example, a massage course including warm massage is selected with an operation panel, the control unit 40 drives the motor of the massage mechanism 20 and applies predetermined current A1 to the PTC heater 30 (refer to FIG. 6). The maximum output temperature of the PTC heater is Tmax. The control unit 40 uses the temperature sensor 42 to monitor the temperature of the second case member 32, to which the heat of the PTC heater 30 is transferred. When the temperature exceeds an upper limit temperature T1, the control unit 40 applies a predetermined current A2, which has a smaller current value than the current A1, to the PTC heater 30. The control unit 40 controls the temperature of the heater unit 23, which is formed by the PTC heater 30 and the first and second case members 31 and 32, to be within the range of the upper limit temperature T1 and the lower limit temperature T2 (refer to FIGS. 6 and 7). In parallel, when performing a massage with the rubbing rollers 24, for example, mainly on the neck, as shown in FIGS. 7(a) and 7(b), the control unit 40 controls the motor of the massage mechanism 20 and moves the massage mechanism 20 to where the user's neck is located. Then, the control unit 40 moves each arm 22 with a motor in the lateral direction to produce a squeezing motion with the two rubbing rollers 24 and massage the user's neck. Here, the fixed member 25, which projects inward in the lateral direction from the rubbing roller 24, abuts the user's neck through the cover 13b and conducts heat from the PTC heater 30 to the user's neck.

When performing a massage with the rubbing rollers 24 mainly on the back in parallel with the temperature control of the heater unit 23, as shown in FIGS. 8(a) and 8(b), the control unit 40 controls the motor of the massage mechanism 20 and moves the massage mechanism 20 to where the user's back is located. The control unit 40 moves the arm 22 with motors in up to down, left to right (lateral), and front to rear directions, to produce a pressing motion or the like with the two rubbing rollers 24 and massage the user's back. Here, the rubbing roller 24 elastically deforms so that the heater unit 23 (the abutment portion 32d of the second case member 32 shown in FIGS. 2 and 3) abuts the user's back through the cover 13b and transfers heat from the PTC heater 30 to the user's back.

As described above, the heater unit 23 and the fixed member 25 allows for the transfer of heat to the user's body. In comparison with the massage machine of the prior art, this enlarges the area over which heat is applied to the user. Thus, heat from the PTC heater 30, which serves as a heat source, can be transferred in a preferred manner. Further, the fixed member 25 projects inward in the lateral direction from the rubbing roller 24. Thus, when the rubbing rollers 24 massage the user's neck or the like from opposite sides, the fixed member 25 contacts the user through the cover 13b. This transfers heat from the PTC heater 30 in a further preferred manner. Further, the power supply wire 35 is fixed to the arm 22. Thus, when moving the massage mechanism 20 and the massaging elements 21 (arms 22) with motors, entanglement of the power supply wire 35 with the massage mechanism 20 and the massaging elements 21 is suppressed. Further, bending and tensing of the power supply wire 35 are suppressed. This reduces the occurrence of wire breakage or the like in the power supply wire 35.

Further, the rubbing roller 24 is formed by a single elastic member and thus has rigidity and durability that are increased as compared to a separable type rubbing roller of the prior art. Further, the arm 22 is fixed to the first and second case members 31 and 32. Thus, the distance between the arm 22 and each of the case members 31 and 32 can be decreased. This suppresses the generation of vibration of the case members 31 and 32 when the arm moves 22. As a result, damage of the PTC heater 30, which is accommodated in the case members 31 and 32, is suppressed.

The massage machine 10 of the present embodiment has the advantages described below.

(1) The massaging element 21 includes the heater unit 23, which is connected to the arm 22 of the massage mechanism 20, accommodates the PTC heater 30, and is capable of conducting heat from the PTC heater 30 to the user, and the rubbing roller 24, which presses the user's body. The rubbing roller 24 is supported by the heater unit 23 on the arm 22. In this structure, there is no need for separating a rubbing roller to hold a heat transferring means like in the prior art. In other words, the rubbing roller 24 does not hold the heater unit 23. Thus, the rubbing roller 24 can be formed by a single component. This improves the rigidity and durability of the rubbing roller 24, while conducting heat to the heater unit 23, which is discrete from the rubbing roller 24. Further, the number of components of the rubbing roller 24 can be reduced, and assembling is facilitated during manufacturing.

(2) The rubbing roller 24 is supported by the arm 22 with the heater unit 23. Accordingly, the heater unit 23 functions not only as a heat transfer unit but also as a support unit for the rubbing roller 24. Thus, while preventing the number of components of the massaging element 21 from increasing, the rigidity and durability of the rubbing roller 24 can be improved. In the prior art, the heat transferring means is held between the two separated rubbing roller parts. Thus, a further support unit is required to support the rubbing roller.

(3) The PTC heater 30 is connected to the power supply wire 35, which can supply power to the PTC heater 30, and the power supply wire 35 is fixed to the arm 22. The arm 22 of the massaging element 21 moves together with the massage mechanism 20 and when the rubbing roller 24 presses the body. In this case, the first and second case members 31 and 32, which are connected to the arm 22, follow the movement of the arm 22. Thus, by fastening the power supply wire 35 of the PTC heater 30 to the arm 22, the power supply wire 35 can also be integrally moved. Accordingly, bending and tensing of the power supply wire 35 are suppressed when the arm 22 moves. This reduces the occurrence of wire breakage or the like in the power supply wire 35.

(4) The heater unit 23 includes the first and second case members 31 and 32, and the PTC heater 30 is accommodated between the first and second case members 31 and 32 so as to transfer heat to both of the first and second case members 31 and 32. Accordingly, the heat of the heater 30 is directly transferred to the second case member 32 and also transferred from the first case member 31 to the second case member 32. Thus, in comparison with when conducting heat to only the second case member 32 heat transfer loss is reduced, and a low capacity heat source can be used.

(5) The PTC heater 30 is in contact with the first case member 31. This ensures that heat from the PTC heater 30 is transferred to the first case member 31, and heat transfer loss is reduced in comparison to a structure in which the first case member 31 does not abut the PTC heater 30. Thus, a heat source having a further lower capacity can be used.

(6) The two massaging elements 21 are arranged in the lateral direction of the backrest 13. The heater unit 23 is connected to the fixed member 25 inward in the lateral direction from the heater unit 23. The heater unit 23 is coupled in a removable manner to the fixed member 25, and the rubbing roller 24 is supported by the fixed member 25 and the heater unit 23. The fixed member 25 is thermally conductive and can transfer the heat of the heater unit 23 to the user. In this manner, two different members supporting the rubbing roller 24 in the lateral direction, that is, the heater unit 23 and the fixed member 25 transfer heat from the heater 30 to the user to transfer heat to the user's body over a wider area. For example, when the rubbing rollers 24 massage the user's neck or the like from opposite sides, the neck is located inward in the lateral direction from the rubbing rollers 24. Thus, when massaging the user's neck, heat can simultaneously be transferred to the user's neck by the fixed member 25. Further, the heater unit 23 is arranged outward in the lateral direction from the rubbing roller. Thus, when massaging the users neck or the like from opposite sides with the rubbing rollers 24, the heater unit 23, which is larger than the fixed member 25, is prevented from providing the user with a different feel from the rubbing roller 24 (discomfort).

(7) The first and second case members 31 and 32 accommodate the PTC heater 30. In this manner, by forming the accommodation component for the PTC heater 30 from a plurality of members, the PTC heater 30 can easily be accommodated in the heater unit 23.

(8) The rubber pad 41, which serves as an impact absorption member, is arranged between the heater unit 23 and the PTC heater 30, which is arranged in the heater unit 23. This reduces load (chattering or the like) produced between the first and second case members 31 and 32 and the PTC heater 30, and suppresses damage or the like to the PTC heater 30.

(9) The rubber pad 41, which serves as a high thermal conductance member, is arranged between the heater unit 23 and the PTC heater 30, which is arranged in the heater unit 23. The rubber pad 41 reduces in size an air gap between the PTC heater 30 and the heater unit (second case member 32 in the present embodiment), and thermal conductance from the PTC heater 30 to the second case member 32 can be increased. Thus, heat can be efficiently transferred from the PTC heater 30 to the user.

The above embodiment of the present invention may be modified as described below.

In the above embodiment, among the first and second case members 31 and 32, only the second case member 32 can be formed from a thermally conductive material, and the first case member 31 can be formed from a thermally insulative material. However, when the first case member 31 is thermally conductive like in the above embodiment, heat can be conducted to the second case member 32 from the first case member 31 in addition to the heater 30. This improves the thermal conductance (refer to advantage (4)).

In the above embodiment, the PTC heater 30 is held between the abutment portion 31c of the first case member 31 and the rubber pad 41, which is arranged in the second case member 32, to prevent chattering of the PTC heater 30. However, the present invention is not limited to such a structure, and other members may be used to prevent chattering of the PTC heater 30.

In the above embodiment, the rubber pad 41, which serves as an impact absorption member and a high thermal conductance member, is arranged between the second case member 32 and the PTC heater 30. Instead of or in addition to the rubber pad 41 another member, such as thermal conductance grease or a Belleville spring, may be used.

The second case member 32 and the PTC heater 30 may be in direct contact with each other. In other words, the rubber pad 41 may be eliminated. In contrast with when a gap or another member is provided, direct contact of the PTC heater 30 and the second case member 32 prevents the thermal conductance from decreasing and efficiently transfers heat to the abutment portion 32c and the fixed member 25.

In the above embodiment, the PTC heater 30 abuts the abutment portion 31c of the first case member 31. However, abutment of the first case member 32 is not necessary as long as the heater 30 directly abuts the second case member 32 or indirectly contacts the second case member 32 through the rubber pad 41. That is, the heater 30 only needs to abut at least the second case member 32 including abutment portion 32d (opposing portion) opposing the user's body.

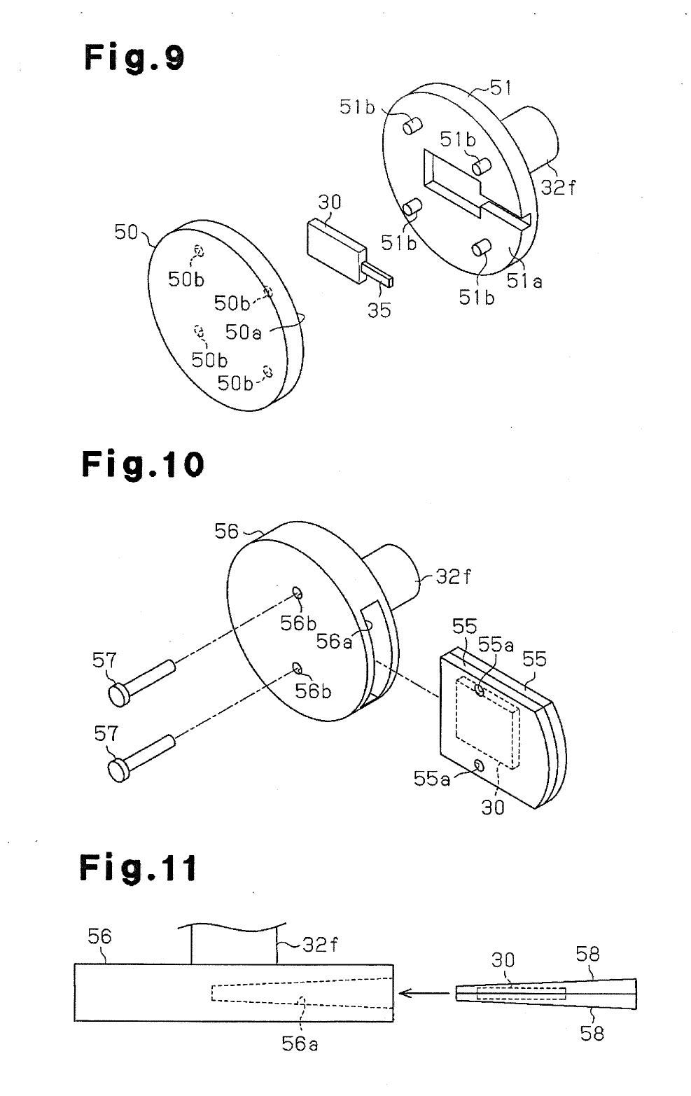

In the above embodiment, the PTC heater 30 is accommodated in the first and second case members 31 and 32. However, the structure of the heat transfer unit that accommodates the heat source may be changed. For example, as shown in FIG. 9, instead of the first and second case members 31 and 32, the PTC heater 30 may be accommodated in a first accommodation member 50 and a second accommodation member 51. Such a structure also transfers the heat of the PTC heater 30 to an extension 32f of the second accommodation member 51 while preventing chattering of the heater 30 in the first and second accommodation members 50 and 51. The first accommodation member 50 includes an inner surface 50a facing the second accommodation member 51, and the inner surface 51a includes recesses 50b. The second accommodation member 51 includes an inner surface 51a facing the first accommodation member 50, and the inner surface 51a includes protrusions 51b formed at locations corresponding to the recesses 50b. Further, the inner surface 51a includes an accommodation pit, which holds the PTC heater 30. The protrusions 51b and the recesses 50b function as alignment portions that align the first and second accommodation members 50 and 51. In this structure, alignment of the first accommodation member 50 and second accommodation member 51, which accommodate the PTC heater 30, is facilitated. This facilitates assembling during manufacturing. Although not shown in the drawings, the outer surface of at least one of the first and second accommodation members 50 and 51 functions as an abutment similar to the abutment portion 32d (opposing portion) of FIG. 3 opposing the user's body.

In lieu of the first and second case members 31 and 32, the structure of the heat transfer unit that accommodates the heat source may be changed as shown in FIG. 10. The heat transfer unit of FIG. 10 includes two planar accommodation portions 55, which hold the PTC heater 30 in between, and a generally circular disk portion 56, into which the two accommodation portions 55 can be inserted. The two accommodation portions 55 holding the heater 30 are inserted into the disk portion 56 from an insertion hole 56a, which is formed in the peripheral surface of the disk portion 56. Although not shown in the drawings, the peripheral surface of the disk portion 56 (or the peripheral surfaces of the accommodation portions 55 exposed from the disk portion 56) functions as an abutment portion (opposing portion opposing the user's body) in the same manner as the abutment portion 32d. Even with such a structure, chattering of the heater 30 in the disk portion 56 can be prevented, and the heat of the heater 30 can be transferred by the accommodation portions 55 to an extension 32f of the disk portion 56. In FIG. 10, as positioning portions that align the accommodation portions 55 and the disk portion 56, for example, two through holes 55a are formed in the accommodation portions 55 at predetermined positions, and through holes 56b are formed in the disk portion 56 that accommodates the accommodation portions 55 at positions corresponding to the through holes 55a in the axial direction. In this structure, the insertion of aligning pins 57 into the through holes 55a and 56b facilitates the alignment of the accommodation portion 55 and the disk portion 56.

The structure of the positioning portions in FIG. 10 that align the accommodation portions 55 and the disk portion 56 may be changed as shown in FIG. 11. In FIG. 11, the accommodation portions 55 of FIG. 10 are changed to accommodation portions 58, and the insertion hole 56a of the disk portion 56 is tapered. The insertion hole 56a is formed so that its width decreases toward the center of the disk portion 56 in the radial direction, which is located at the downstream side in the insertion direction of the accommodation portions 58. The two accommodation portions 58 holding the heater 30 are formed in accordance with the width of the insertion hole 56a in the disk portion 56. That is, the two accommodation portions 58 include a thick part and a thin part. In this structure, the insertion of the accommodation portions 58 into the insertion hole 56a fits and aligns the accommodation portions 58 and insertion hole 56a with each other.

Although not particularly mentioned in the above embodiment, the abutment portion 32d, which is the portion opposing the user's body, may be formed by a high thermal conductance member having a higher thermal conductance than other parts (e.g., the main body portions of the first and second case members 31 and 32). For example, the abutment portion 32d may be formed from aluminum, and the main body portions of the case members 31 and 32 may be formed from a thermally conductive resin. In this structure, the heat from the PTC heater 30 can be concentrated from the main body portion of the second case member 32 to the abutment portion 32d. Thus, heat can be efficiently transferred to the user's body.

In the above embodiment, the first case member 31 and the second case member 32 are formed from aluminum, which is a high conductance member. However, the present invention is not limited in such a manner, and the first and second case members 31 and 32 may be formed by other members of metal, such as gold or copper, having high thermal conductance.

In the above embodiment, the power supply wire 35, which is connected to the PTC heater 30, is fixed to the arm 22. However, the present invention is not limited in such a manner, and the PTC heater 30 does not have to be fixed to the arm 22.

In the above embodiment, the power supply wires 35 and 38, which supply power to the PTC heater 30 serving as a heat source, electrically connects the control unit 40 and the PTC heater 30 using the connector 37 as a relay. However, the present invention is not limited in such a manner. For example, the connector 37 may be eliminated, and the control unit 40 and PTC heater may be electrically connected by a single power supply wire.

In the above embodiment, the fixed member 25 is formed from aluminum, which is a material having high thermal conductance. However, other materials may be used. Further, the fixed member 25 may be formed from a thermally insulative material.

In the above embodiment, the diameter of the fixed member 25 has a slightly larger diameter that the rubbing roller 24. However, the present invention is not limited in such a manner.

In the above embodiment, the first case member 31 and second case member 32, which accommodate the PTC heater 30, are arranged outward n the lateral direction from the rubbing roller 24. However, the first case member 31 and the second case member 32 may be arranged inward in the lateral direction from the rubbing roller 24. In this case, the fixed member 25 is arranged outward in the lateral direction from the rubbing roller 24. Here, in the present invention, “a rubbing roller supported by the heat transfer unit on the arm” does not specify a simple positional relationship of the heater unit 23 (heat transfer unit), the rubbing roller 24, and the arm 22 but specifies that the rubbing roller 24 is supported by the arm 22 using the heater unit 23 (heat transfer unit). In the above embodiment, the heater unit 23 and the fixed member 25 hold the rubbing roller 24. However, the method for supporting the rubbing roller 24 is not limited to “holding” the rubbing roller 24. For example, the rubbing roller 24 may be supported by only the heater unit 23, which is connected to the arm 22, or only the fixed member 25, which is connected to the heater unit 23.

In the above embodiment, aluminum is used as the material of the first case member 31 and the second case member 32. However, other material may be used to form the case members 31 and 32. The material of the second case member 32, which is arranged inward in the lateral direction from the first case member 31, may have a higher thermal conductance than the material of the first case member 31 so that the heat of the heater 30 is efficiently transferred to the second case member 32.

In the above embodiment, the fixed member 25 projects inward in the lateral direction of the backrest 13 from the rubbing roller 24. However, the present invention is not limited in such a manner.

Although not particularly mentioned in the above embodiment, the extension 32f and the cylindrical portion 25a are designed with high dimensional accuracy to increase adhesion and thermal conductivity from the heater unit 23 to the fixed member 25. Further, a fixed gap (air layer) may be arranged between the extension 32f and the cylindrical portion 25a, and the gap may be filled with a heat conductive member such as heat conductive grease.

In the present embodiment, the PTC heater 30 is used as the heat source of the heater unit 23. However, other heat sources may be used.

In the above embodiment, the rubbing roller 24 is rotatable about the cylindrical portion 25a due to the bearings 24a and 24b but may be supported so that rotation is prohibited.

Although not particularly mentioned in the above embodiment, a lubricant, such as grease, may be applied to the contact surface of the rubbing roller 24 that contacts the cover 13b. This suppresses friction between the rubbing roller 24 and the cover, and the durability of the rubbing roller 24 and the cover 13b can be improved.

Although not particularly mentioned in the above embodiment, a massaging means such as an airbag may be arranged in the upper surface of the ottoman 14 or the seat 12.

In the above embodiment, the backrest 13 is reclinable. However, the backrest 13 may be non-reclinable.

In the above embodiment, the ottoman 14 is arranged at the front part of the seat 12. However, the ottoman 14 may be eliminated.

1. A massage machine comprising:
a seat;
a backrest;
a massage mechanism arranged in the backrest; and
a massaging element arranged in the massage mechanism, wherein the massaging element includes:
an arm connected to the massage mechanism;
a heat transfer unit connected to the arm, wherein the heat transfer unit accommodates a heat source and is capable of transferring heat from the heat source to a user; and
a rubbing roller supported by the heat transfer unit on the arm.

2. The massage machine according to claim 1, further comprising a power supply wire connected to the heat source and capable of supplying power to the heat source, wherein the power supply wire is fixed to the arm.

3. The massage machine according to claim 1, wherein the massage element is one of two massage elements arranged in a lateral direction of the backrest, the massage machine further comprising a fixed member connected in a removable manner to the heat transfer unit inward in the lateral direction of the backrest from the heat transfer unit, wherein:
the rubbing roller is supported by the heat transfer unit and the fixed member; and
the fixed member is thermally conductive and capable of transferring heat from the heat transfer unit to the user.

4. The massage machine according to claim 1, wherein:
the heat transfer unit includes:
a first case member connected to the arm; and
a second case member connected to the first case member; and
the heat source is accommodated between the first and second case members and capable of transferring heat to both of the first and second case members.

5. The massage machine according to claim 1, wherein the heat transfer unit includes a plurality of members that accommodate the heat source.

6. The massage machine according to claim 5, wherein:
the plurality of members include a member provided with an opposing portion opposing the user's body; and
the heat source is arranged to abut at least the member provided with the opposing portion.

7. The massage machine according to claim 1, wherein:
the massaging element is one of two massaging elements arranged in a lateral direction of the backrest;
the heat transfer unit includes a first accommodation member, which is located outward in the lateral direction of the backrest from the heat source, and a second accommodation member, which is located inward in the lateral direction of the backrest from the heat source;
the second accommodation member includes an opposing portion opposing the user's body; and
the heat source is arranged to abut at least the second accommodation member.

8. The massage machine according to claim 5, wherein:
the plurality of members include a member provided with an opposing portion opposing the user's body; and
the opposing portion is formed by a high thermal conductance member having a higher thermal conductivity than other portions of the member provided with the opposition portion.

9. The massage machine according to claim 5, wherein the heat transfer unit further includes an alignment portion that aligns the plurality of members.

10. The massage machine according to claim 1, wherein the heat transfer unit includes an impact absorption member arranged between the heat transfer unit and the heat source.

11. The massage machine according to claim 1, wherein the heat transfer unit includes a high thermal conductance member arranged between the heat transfer unit and the heat source.

12. The massage machine according to claim 2, wherein the massage element is one of two massage elements arranged in a lateral direction of the backrest, the massage machine further comprising a fixed member connected in a removable manner to the heat transfer unit inward in the lateral direction of the backrest from the heat transfer unit, wherein:
the rubbing roller is supported by the heat transfer unit and the fixed member; and
the fixed member is thermally conductive and capable of transferring heat from the heat transfer unit to the user.

13. The massage machine according to claim 2, wherein:
the heat transfer unit includes:
a first case member connected to the arm; and
a second case member connected to the first case member; and
the heat source is accommodated between the first and second case members and capable of transferring heat to both of the first and second case members.

14. The massage machine according to claim 2, wherein:
the massaging element is one of two massaging elements arranged in a lateral direction of the backrest;
the heat transfer unit includes a first accommodation member, which is located outward in the lateral direction of the backrest from the heat source, and a second accommodation member, which is located inward in the lateral direction of the backrest from the heat source;
the second accommodation member includes an opposing portion opposing the user's body; and
the heat source is arranged to abut at least the second accommodation member.
